(19) United States
(12) Patent Application Publication
(10) Pub. No.: US 2024/0303658 A1
(43) Pub. Date: Sep. 12, 2024

(54) COMPUTER GENERATED CONFIRMATION IMAGE

(71) Applicant: Wells Fargo Bank, N.A., San Francisco, CA (US)

(72) Inventors: Gerard K. Cohen, San Francisco, CA (US); Shelby E. Little, San Francisco, CA (US)

(21) Appl. No.: 16/949,507

(22) Filed: Oct. 30, 2020

(51) Int. Cl. G06Q 20/40; G06F 21/36; G06K 9/00; G06K 9/34

(52) U.S. Cl. CPC G06Q 20/4014; G06F 21/36; G06V 30/148; G06V 30/414; G06V 30/416

(57) ABSTRACT

Systems and techniques for computer generated confirmation image are described herein. A selection of a transaction type may be obtained from a user. A captured image may be received that is associated with the transaction type. The captured image may be evaluated to extract a set of data elements. The confirmation image may be generated using an image template and the set of data elements. The confirmation image may be transmitted to a display device for viewing by a user and the data elements may be transmitted to a transaction processing engine for completion of a transaction.

### TECHNICAL FIELD

Embodiments described herein generally relate to computerized image enhancement and, in some embodiments, more specifically to computer generation of an enhanced confirmation image for data capture from an image.

### BACKGROUND

A user may desire to capture an image of an object to process a transaction. Data may be obtained from the captured image to facilitate processing of the transaction. The accuracy of data captured from the image may be important for completion of the transaction.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for computer generated confirmation image, according to an embodiment.

FIG. 2 illustrates a flow diagram of an example of a process for computer generated confirmation image, according to an embodiment.

FIG. 3 illustrates an example of a method for computer generated confirmation image, according to an embodiment.

FIG. 4 is a block diagram illustrating an example of a machine upon which one or more embodiments may be implemented.

### DETAILED DESCRIPTION

The systems and techniques discussed herein provide a data validation solution during remote deposit capture of a check (e.g., via mobile device, desktop computing device, etc.) or other image based transaction processes to display an enhanced verification image of an object to be used in transaction processing (e.g., a captured check, etc.). Rather than displaying the captured image of the check upon completion of the image capture process, a computer-generated image is generated using data harvested (e.g., recognized, scraped, learned, etc.) from the captured image of the object. The captured check is recreated using static text harvested from the image and applied to a template that may be an image. An image is not generated from the harvested, but rather static text parsed from the captured image using assistive technology is superimposed on a template that may include a background image and areas (e.g., fields, etc.) where the harvested data may be superimposed. This presents a composite visual representation of the harvested data that allows the user to confirm accuracy of the data.

The computer-generated image may be generated from a stock image of an object (e.g., a check, etc.) and is overlaid (e.g., populated, etc.) with the data harvested from the captured image of the object. For example, a stock image of a check may be updated with account/routing numbers, courtesy amount recognition (CAR)/legal amount recognition (LAR), date, memo line, check writer name, etc. In an example, the data from the image may be harvested by analyzing the image of the object using optical character recognition (OCR) techniques. The computer-generated image may be presented to the user as a representation of how the data recognized in the analysis of the image of the object was interpreted. The user may be presented with a request to approve, modify (e.g., provide a corrected amount, memo, etc.), or retake the image. Upon approval of the generated image, the image (or data harvested from the image) will be used in completing the requested transaction.

The solution discussed herein may build off a remote capture flow and may be applied to mobile and desktop versions of remote deposit capture. The general flow for one embodiment for the remote capture of checks is described below.

Example General Flow:

1. A user may authenticate and select deposit check through appropriate channel (e.g., mobile, desktop, etc.).

2. The user captures image(s) of check(s) (e.g., front and back of each check to be deposited). In a desktop setting, this may include multiple checks fed through a scanner. In a mobile setting, this may be single or multiple checks captured through a mobile device (e.g., smartphone, etc.) camera. The image capture may be completed automatically or manually. Examples are provided for capture of a single check but are applicable to instances where multiple checks may be captured.

3. The captured image of the check is analyzed. Analysis may be performed on the mobile device or a remote server or both. Image quality assessment (IQA) is performed to determine if the image meets the requirements needed to be deposited in place of a paper check. OCR is performed to collect information on the check from the check itself. Text (e.g., handwritten, typed, magnetic ink character recognition (MICR), etc.) may be captured from both sides of the check. At the minimum, MICR and amount are captured.

4. An image of a check is generated that is populated with the OCR-ed information. This is a new computer-generated image—not the captured image. In an example, the new computer-generated image may be generated from a template of a generic check that is then populated with information as interpreted from the OCR process performed on the captured image of the check. The background of the generated image of the check may be customized to match the captured image of the check. For example, if the check includes logos and colors of a financial institution, the template may be updated to include these features. In an example, a library of check templates may be maintained that have different artistic characteristics. The check template used may be selected based on its similarity to the actual check being deposited, may be predefined by a user, predefined by a sender, etc. Senders that are customers of a particular financial institution, as determined automatically when reviewing the check information, may select a template that will be used by other financial institution customers. The computer-generated image is a template base image overlaid with static text from OCR results and thus the computer-generated image may not be a true image file, but rather a composite of a template image and the static text. Additionally or alternatively, rather than generating an image of a check, a user interface may be displayed to the user to provide the check information in another format (e.g., a set of fields with relevant info, etc.). The user interface may be customizable by the user.

5. The new computer-generated image is presented to the user in lieu of the captured image of the check.

6. The user may confirm that the analysis of the check matches the information on the paper check. If not, the user may retake or provide updates via a user interface presented with the new computer-generated image (e.g., correct amount or account number, amount, etc.).

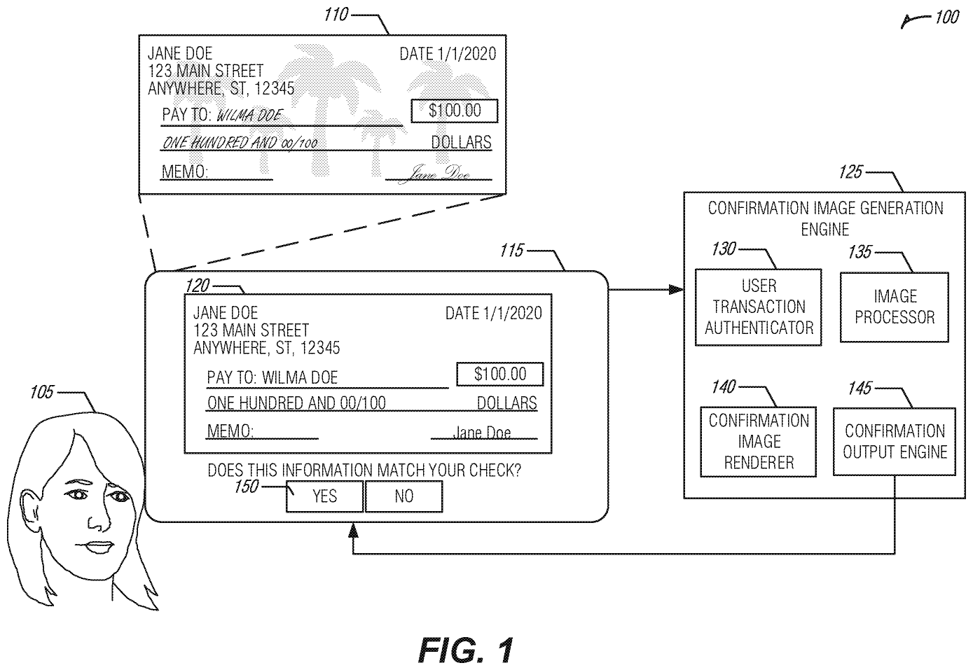

FIG. 1 is a block diagram of an example of an environment 100 and a system 125 for computer generated confirmation image, according to an embodiment. The environment 100 may include a user 105 that may be capturing an image of a check 110 using an imaging sensor of a device 115 that is communicatively coupled (e.g., via a wired network, wireless network, shared bus, etc.) to the system 125. In an example, the system 125 may be a confirmation image generation engine. While the examples below describe an image of a check, images of other objects (e.g., a driver license, credit card, debit card, etc.) may be similarly processed to provide a confirmation image to the user 105.

The system 125 may include a variety of components including a user authenticator 130, an image processor 135, a confirmation image renderer 140, and a confirmation output engine 145. The system 125 may generate a new image of a check using a check image template and data collected from the check. The system 125 and its components may reside on one or more servers remote from the mobile device. In other embodiments, some or all of the system 125 functionality may reside on the mobile device or be shared between the mobile device and a remote server.

In an example, the device 115 may be a mobile device and the system 125 may be an application executing on the mobile device and the user authenticator 130, the image processor 135, the confirmation image renderer 140, and the confirmation output engine 145 may be components of the application executing on the mobile device. In another example, the device 115 may be a desktop device or other device that is coupled to a scanning device (not shown). A document (e.g., the check 110) may be captured by the scanning device and passed to the system 125. The system may be a locally installed application executing on the desktop device, a cloud-based application, a web-based application access by a web browser, etc. In yet another example, the device 115 may be the scanning device commutatively coupled to the desktop device (e.g., via wired network, wireless network, the internet, cellular network, etc.) and the system 125 may be executing on the desktop device. The components of the system 125 may be hosted on a remote server in communication with the device 115 and the system 125 via a network (e.g., wireless network, wired network, cellular network, shortwave radio network, etc.). It will be understood that the device 115, system 125, the user authenticator 130, the image processor 135, the confirmation image renderer 140, and the confirmation output engine 145 may be implemented in various configurations (e.g., each executing on an independent computing device/platform, all on a single computing device, subsets running on a subsets of computing devices, distributed across computing devices, etc.) of computing devices, field-programmable gate arrays (FPGAs), cloud-computing services, virtualized computing platforms, mobile computing devices, wearable computing devices, and the like. For example, the user authenticator 130 may be executing on a remote server while the image processor 135 confirmation image render 140 and confirmation output processor 145 may be executing on a cloud-service platform or a desktop computing device.

The user transaction authenticator 130 may collect authentication information and transaction selection information from the user 105 and may authenticate the user 105 for completion of the transaction. For example, the user 105 may desire to deposit a check using the device 115 and the user may provide login credentials and may select a check deposit transaction type. The user transaction authenticator 130 may validate the login credentials (e.g., locally, remotely, etc.) and that the user 105 is authorized to complete the deposit check transaction. Upon authentication, the user may be presented with a user interface for capturing the image of the check 110 via the imaging sensor of the device 115.

The image processor 135 may obtain the image of the check 110 and may perform a set of image analysis processes on the image of the check 110. The image processor 135 may evaluate the image of the check 110 for image quality to determine if the image of the check 110 meets a threshold quality level for data collection. For example, the image may be evaluated to assess brightness, contrast, etc. to determine if the image of the check 110 is suitable for data collection. In an example, the assessment may use individual thresholds for image attributes of images suitable for data collection. In another example, a probabilistic approach may be used to determine a likelihood of success of data collection based on image quality attributes of the image of the check 110. If the image does not pass the image quality assessment, the user may be prompted to capture a new image of the check 110 and another image quality assessment may be completed.

Upon determining the image of the check 110 meet the standards for data collection, the image processor 135 may evaluate the image of the check 110 to collect data from the image. In an example, optical character recognition (OCR) techniques may be used to collect text from the image of the check 110. For example, the amount, routing number, account number, MICR data, etc. may be collected from the image of the check 110. In another example, computer vision may be used to recognize images and non-character objects in the image of the check 110. For example, logos, signatures, etc. that may not be recognized as text may be captured and evaluated. For example, a signature on the check 110 may be identified that may be compared to a reference signature to determine authenticity. The image processor 135 may classify the collected data based on attributes of data elements in the collected data. For example, a string of numerals may be classified as a routing number based on string length, a match between the sequence of numerals and a set of known routing numbers, position within the image of the check 110, etc. The classification may assign a field identifier to the data element. In another example, the image processor may assign a position identifier to data elements recognized in the image of the check 110.

The confirmation image renderer 140 may select a check image template to use as the base of a new composite check image generated from the data collected from the image of the check 110 by the image processor 135. For example, the confirmation image renderer 140 may select an image template from a template library based on a routing number collected form the image of the check 110, an image detected in the image of the check, a user preference, etc. In another example, a default image template may be selected if the confirmation image renderer 140 does not find a matching image in the template library. In an example, the image template may include a set of fields with corresponding field identifiers and data elements captured from the image of the check 110 may be place in corresponding fields based on their assigned field identifier. In another example, the template may be populated with the data elements collected from the image of the check 110 based on their respective position identifiers. The confirmation image renderer 140 generates a confirmation image 120 that represents the results of the evaluation of the image of the check 110. The data elements may be static text that may be applied to the template image to form a composite of the template image and the static text.

The confirmation output engine 145 may output the confirmation image 120 to the user 105. In an example, the confirmation image 120 may be output with confirmation user interface elements 150 that are interactive and allow the user 105 to accept or reject the confirmation image 120 as an accurate representation of the check 110. If the user 105 rejects the confirmation image 120, the confirmation output engine 145 may present the user 105 with an interface to capture a new image of the check 110 in which case the process is repeated. In another example, the confirmation output engine 145 may output a user interface that allows the user 105 to manually manipulate (e.g., edit, etc.) the data elements included in the confirmation image 120. For example, the data elements collected from the image of the check 110 may be placed in text boxes and the user 105 may be able to place a cursor within the text box to add, remove, or otherwise edit the data element. Upon acceptance of the confirmation image 120, the data on the confirmation image (and the original image of the check 110) may be used to complete the transaction. In another embodiment, the confirmation output engine 145 may simply output the confirmation image, and the user may simply push a submit button to complete a transaction. In some embodiments, a thumbnail image of the confirmation image may be displayed, and the user may optionally select a thumbnail image to view the image and optionally be presented with UI elements to approve or modify the image.

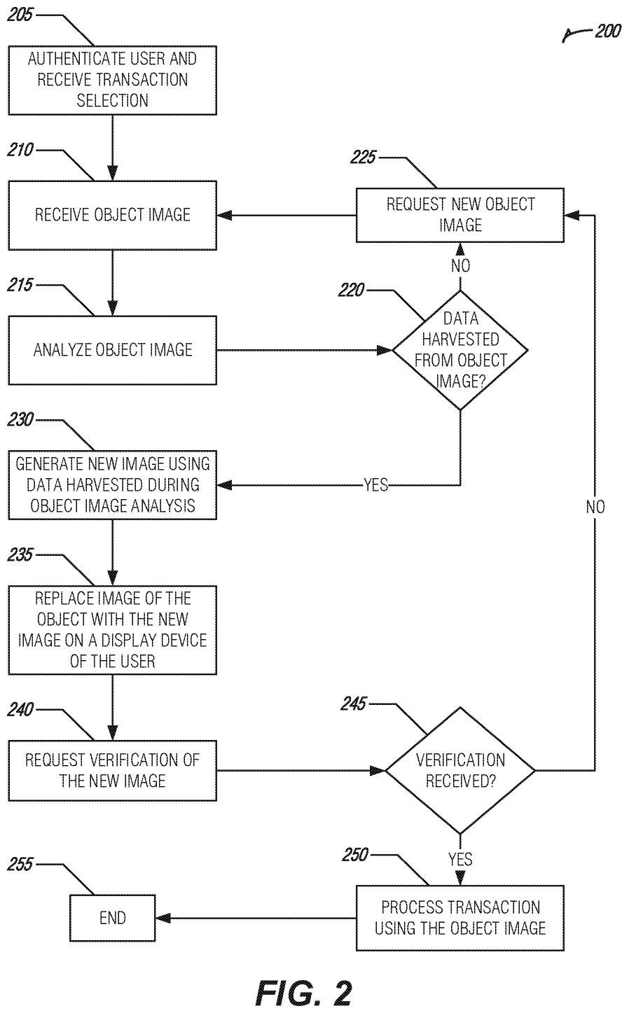

FIG. 2 illustrates a flow diagram of an example of a process 200 for computer generated confirmation image, according to an embodiment. The process 200 may provide features as described in FIG. 1.

A user may desire to perform a transaction that uses data collected from an image of an object in execution of the transaction. At operation 205 the user may provide credentials and a selection of a transaction to be executed. For example, the user may wish to deposit a check by capturing an image of the check. The user credentials may be evaluated for the selected transaction to determine that the user is authorized to execute the selected transaction.

The user may be presented with a user interface for capturing an image of the object. For example, a camera application may be launched and presented to the user to capture the image of the object. At operation 210, the object image may be received. For example, an image of a check may be received through an automatic or manual capture of the check via an imaging sensor of a smartphone.

At operation 215, the object image is analyzed to determine if the captured image meets quality criteria for data collection. If so, the image is procced using data recognition techniques to collect and classify data detected in the image of the object. For example, text, images, etc. may be collected from the image of the check. If the image of the object does not meet the quality criteria, the user may be prompted to recapture the object.

At decision 220, it may be determined if data was harvested from the image of the object. If no data was collected, the user may be prompted to capture a new image of the object at operation 225 and the process 200 continues at operation 210. If data was collected, as indicated at decision 220, a new image of the object may be generated at operation 230. The new image constitutes a confirmation image the is composed of an image template and data collected from the image of the object. In an example, the image template may be selected as a base of the new image and the data collected from the image of the object may be overlaid or otherwise displayed on the image template.

At operation 235, the image of the object (e.g., the image captured by the user, etc.) may be replaced with the confirmation image on the display device of the user's device. For example, the captured image of the check may be displayed on the display device while the image is being captured and may be replaced by the confirmation image of the check when the evaluation of the image of the check is complete.

At operation 240, a user interface may be presented to the user requesting verification of the confirmation image of the object. For example, the user may receive a prompt on the display device requesting a yes or no response to a query regarding whether a confirmation image of the check accurately represents the data of the original check. In other embodiments, the confirmation image may be available for viewing by the user, but an approval is not required. A user may be requested to provide an input (push a button, provide a verbal command) to submit the check for deposit. In these embodiments, flow moves from 240 to 250.

At decision 245, it is determined if a verification has been received (in embodiment where verification is used). If a user does approve the image, the user may be requested to capture a new image of the object at operation 225. Additionally, or alternatively, the user may be presented with a user interface with interactive user interface elements that may be activated by the user to modify data on confirmation image of the object.

When approval verification has been received, as indicated at decision 245, the transaction may be processed using the object image (or data from the confirmation image) at operation 250. The process 200 ends at operation 255

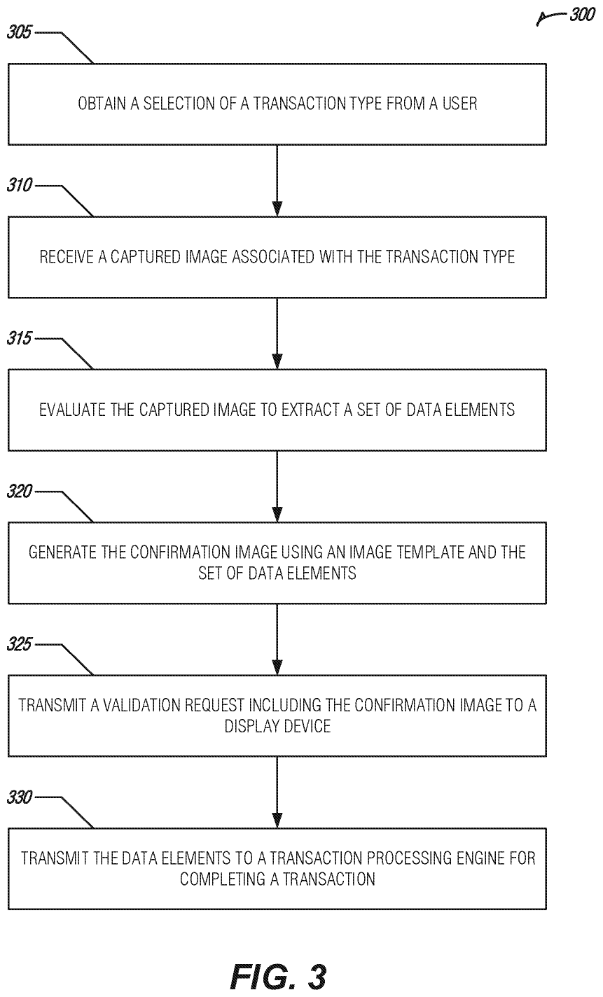

FIG. 3 illustrates an example of a method 300 for computer generated confirmation image, according to an embodiment. The method 300 may provide features as described in FIGS. 1 and 2.

At operation 305, a selection of a transaction type may be obtained from a user. In an example, authentication credentials may be obtained from the user. An authentication request may be transmitted to a transaction processing engine that includes the authentication credentials and the transaction type. Upon obtainment of an authentication approval response, an image capture user interface may be output to the user. In one example, a user authenticates to a remove server and is served a web page whether the user may select an option to deposit a check (e.g., a transaction type).

At operation 310, a captured image may be received that is associated with the transaction type. In an example, the capture image may an image of a check, a driver license, a credit card, a debit card, a document, etc.

At operation 315, the captured image may be evaluated to extract a set of data elements. In an example, attributes of the captured image may be evaluated to determine a quality level of the captured image and evaluation of the captured image to extract the set of data elements may be initiated in response to a determination that the quality level is outside a threshold. In an example, the set of data elements may be extracted using optical character recognition.

At operation 320, the confirmation image may be generated using an image template and the set of data elements. In an example, the image template may be selected from a library of image templates using the set of data elements. In example, data elements of the set of data elements may be classified and a set of data fields of the image template may be populated based on a match between respective classifications of the data elements and classes of the data fields of the set of data fields.

At operation 325, a confirmation output that includes the confirmation image may be transmitted to a display device. A validation response may be requested and/or the user may be prompted to submit the check for deposit.

At operation 330, upon receipt of a validation response to the validation request and/or a submit request, the data elements may be transmitted to a transaction processing engine for completion of a transaction.

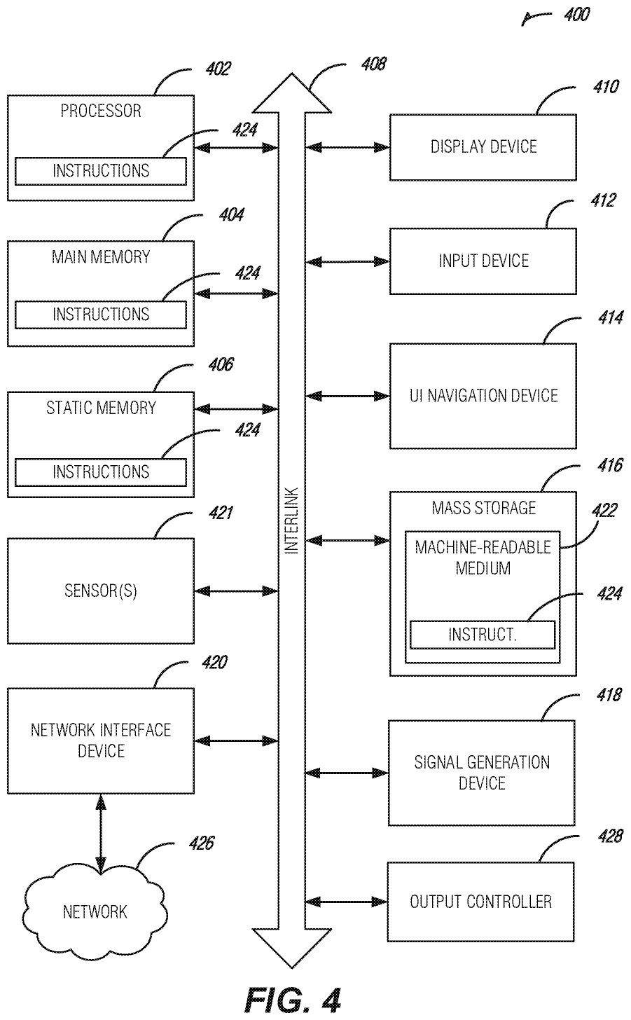

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensors. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for computer generation of a confirmation image comprising:
at least one processor; and
memory including instructions that, when executed by the at least one processor, cause the at least one processor to perform operations to:
receive a captured image of a document;
calculate a set of image quality attributes for the captured image, an image quality attribute of the set of image quality attributes defining a value of a visual characteristic of the captured image;
evaluate the set of image quality attributes to determine a probability that data extraction from the captured image will result in an accurate set of data elements;
in response to the probability that data extraction from the captured image will result in an accurate set of data elements being outside a probability threshold, evaluate the captured image using optical character recognition to extract the set of data elements, wherein the optical character recognition identifies a field of magnetic ink character recognition printing, and wherein the set of data elements includes the characters captured from the field of magnetic ink character recognition printing;
extract a set of visual elements from the captured image;
query image templates in an image template library using the set of visual elements to select an image template, the image template selected based on a similarity between visual elements of the image template and the set of visual elements extracted from the captured image;
receive an image template selected by a user from a set of image templates, the selected image template having a different format from the captured image;
compose a base image using the selected image template;
generate the confirmation image by superimposing the set of data elements extracted from the captured image over the base image;
transmit the confirmation image to a user interface for viewing by a user; and
upon receipt of a confirmation response from the user, transmit the set of data elements to a transaction processing engine for completing a transaction.

2. The system of claim 1, the memory further comprising instructions that cause the at least one processor to perform operations to:
obtain a selection of a transaction type from the user, wherein the captured image is associated with the transaction type;
obtain authentication credentials of the user;
transmit an authentication request to the transaction processing engine including the authentication credentials and the transaction type; and
upon obtainment of an authentication approval response, output an image capture user interface to the user.

3. The system of claim 1, wherein the captured image is an image of a check.

4. The system of claim 1, the memory further comprising instructions that cause the at least one processor to perform operations to:
evaluate attributes of the captured image to determine a quality level of the captured image, wherein evaluation of the captured image to extract the set of data elements is initiated in response to a determination that the quality level is outside a threshold.

5. The system of claim 1, wherein the set of data elements is extracted using optical character recognition.

6. The system of claim 1, the memory further comprising instructions that cause the at least one processor to perform operations to:
select a second image template from a library of image templates using the set of data elements, the second image template having a different format from the captured image and the selected image template;
compose a second base image using the second image template; and
generate a second confirmation image by superimposing the set of data elements extracted from the captured image over the second base image.

7. The system of claim 1, wherein the instructions to generate the confirmation image using an image template and the set of data elements further comprises instructions to:
classify data elements of the set of data elements; and
populate a set of data fields of the image template based on a match between respective classifications of the data elements and classes of data fields of the set of data fields.

8. At least one non-transitory machine-readable medium including instructions for computer generation of a confirmation image that, when executed by at least one processor, cause the at least one processor to perform operations to:
receive a captured image of a document;
calculate a set of image quality attributes for the captured image, an image quality attribute of the set of image quality attributes defining a value of a visual characteristic of the captured image;
evaluate the set of image quality attributes to determine a probability that data extraction from the captured image will result in an accurate set of data elements;
in response to the probability that data extraction from the captured image will result in an accurate set of data elements being outside a probability threshold, evaluate the captured image using optical character recognition to extract the set of data elements, wherein the optical character recognition identifies a field of magnetic ink character recognition printing, and wherein the set of data elements includes the characters captured from the field of magnetic ink character recognition printing;
extract a set of visual elements from the captured image;
query image templates in an image template library using the set of visual elements to select an image template, the image template selected based on a similarity between visual elements of the image template and the set of visual elements extracted from the captured image;
receive an image template selected by a user from a set of image templates, the selected image template having a different format from the captured image;
compose a base image using the selected image template;
generate the confirmation image by superimposing the set of data elements extracted from the captured image over the base image;
transmit the confirmation image to a user interface for viewing by a user; and
upon receipt of a confirmation response from the user, transmit the set of data elements to a transaction processing engine for completing a transaction.

9. The at least one non-transitory machine-readable medium of claim 8, further comprising instructions that cause the at least one processor to perform operations to:
obtain a selection of a transaction type from the user, wherein the captured image is associated with the transaction type;
obtain authentication credentials of the user;
transmit an authentication request to the transaction processing engine including the authentication credentials and the transaction type; and
upon obtainment of an authentication approval response, output an image capture user interface to the user.

10. The at least one non-transitory machine-readable medium of claim 8, wherein the captured image is an image of a check.

11. The at least one non-transitory machine-readable medium of claim 8, further comprising instructions that cause the at least one processor to perform operations to:
evaluate attributes of the captured image to determine a quality level of the captured image, wherein evaluation of the captured image to extract the set of data elements is initiated in response to a determination that the quality level is outside a threshold.

12. The at least one non-transitory machine-readable medium of claim 8, wherein the set of data elements is extracted using optical character recognition.

13. The at least one non-transitory machine-readable medium of claim 8, further comprising instructions that cause the at least one processor to perform operations to:
select a second image template from a library of image templates using the set of data elements, the second image template having a different format from the captured image and the selected image template;
compose a second base image using the second image template; and
generate a second confirmation image by superimposing the set of data elements extracted from the captured image over the second base image.

14. The at least one non-transitory machine-readable medium of claim 8, wherein the instructions to generate the confirmation image using an image template and the set of data elements further comprises instructions to:
classify data elements of the set of data elements; and
populate a set of data fields of the image template based on a match between respective classifications of the data elements and classes of data fields of the set of data fields.

15. A method for computer generation of a confirmation image comprising:
receiving a captured image of a document;
calculating a set of image quality attributes for the captured image, an image quality attribute of the set of image quality attributes defining a value of a visual characteristic of the captured image;
evaluating the set of image quality attributes to determine a probability that data extraction from the captured image will result in an accurate set of data elements;
in response to the probability that data extraction from the captured image will result in an accurate set of data elements being outside a probability threshold, evaluating the captured image using optical character recognition to extract the set of data elements, wherein the optical character recognition identifies a field of magnetic ink character recognition printing, and wherein the set of data elements includes the characters captured from the field of magnetic ink character recognition printing:
extracting a set of visual elements from the captured image;
querying image templates in an image template library using the set of visual elements to select an image template, the image template selected based on a similarity between visual elements of the image template and the set of visual elements extracted from the captured image;
receiving an image template selected by a user from a set of image templates, the selected image template having a different format from the captured image;
composing a base image using the selected image template;
generating the confirmation image by superimposing the set of data elements extracted from the captured image over the base image;
transmitting the confirmation image to a user interface for viewing by a user; and
upon receipt of a confirmation response from the user, transmitting the set of data elements to a transaction processing engine for completing a transaction.

16. The method of claim 15, further comprising:
obtaining a selection of a transaction type from the user, wherein the captured image is associated with the transaction type;
obtaining authentication credentials of the user;
transmitting an authentication request to the transaction processing engine including the authentication credentials and the transaction type; and
upon obtaining an authentication approval response, outputting an image capture user interface to the user.

17. The method of claim 15, wherein the captured image is an image of a check.

18. The method of claim 15, further comprising:
evaluating attributes of the captured image to determine a quality level of the captured image, wherein evaluating the captured image to extract the set of data elements is initiated in response to a determination that the quality level is outside a threshold.

19. The method of claim 15, wherein the set of data elements is extracted using optical character recognition.

20. The method of claim 15, further comprising:
selecting a second image template from a library of image templates using the set of data elements, the second image template having a different format from the captured image and the selected image template;
composing a second base image using the second image template; and
generating a second confirmation image by superimposing the set of data elements extracted from the captured image over the second base image.
